(19) United States
(12) Patent Application Publication
(10) Pub. No.: US 2014/0314911 A1
(43) Pub. Date: Oct. 23, 2014

(54) Deep-Sea Fish Oil Capsule and its Preparation Method

(71) Applicant: Shandong Shenghai Health Care Products Co. Ltd, (US)

(72) Inventor: Guixiang Cheng, Zibo (CN)

(73) Assignee: Shandong Shenghai Health Care Products Co., Ltd., Zibo (CN)

(21) Appl. No.: 13/865,949

(22) Filed: Apr. 18, 2013

(51) Int. Cl. A23L 1/30

(52) U.S. Cl. CPC A23L 1/3006
USPC 426/72; 426/282

(57) ABSTRACT

A deep-sea fish oil capsule includes contents and glue. The contents include following parts by weight of raw materials: Deep-sea fish oil 160 parts by weights to 200 parts by weights; Fish Squalene 70 parts by weights to 90 parts by weights; Soybean lecithin 10 parts by weights to 15 parts by weights; Ginkgo extracts 7 parts by weights to 12 parts by weights; Vitamin E 1 part by weights to 3 parts by weights; and Beeswax 15 parts by weights to 30 parts by weights. The glue includes following parts by weights of raw materials: Gelatin 80 parts by weights to 120 parts by weights; Water 80 parts by weights to 120 parts by weights; Glycerin 30 parts by weights to 50 parts by weights; and Brown Iron Oxide 1 part by weights to 3 parts by weights.

### BACKGROUND OF THE PRESENT INVENTION

1. Field of Invention

The invention belongs to the field of health care products, in particular relates to a deep-sea fish oil capsule and its preparation method.

2. Description of Related Arts

As we all know, with the rapid development of national economy and the improvement of people's living standard, people's diet has changed a lot; high cholesterol, atherosclerosis and other diseases accompanied by growingly influence and endanger people's lives and health.

Fish oil is the scavenger of human blood vessels, rich in Eicosapentaenoic Acid (EPA), Docosahexaenoic Acid (DHA) and other ω-3 polyunsaturated fatty acids; the content of its main component, the EPA and DHA is generally more than 34%; this type of polyunsaturated fatty acids can prevent arteriosclerosis, stroke, hypertension, coronary heart disease and heart disease.

In recent years, the study also found that EPA, DHA and other ω-3 polyunsaturated fatty acids can improve brain function, in particular, the role to improve brain memory. The source of the brain function is the activity of neurons; the energy supply of the neurons, the necessary nutrients and the interactions between the neurotransmitters of neurons to a large extent determine the vitality of the brain and cognitive level.

Currently, there are already many health care products and pharmaceuticals for the brain in the market at home and abroad, but most of them have the defects of single nutrient or are not ideal in the effect of improving memory.

### SUMMARY OF THE PRESENT INVENTION

In view of the above defects, the main object of the invention is to provide a deep-sea fish oil capsule with diversified nutritional composition and its preparation method.

In order to achieve the above object, the kind of deep-sea fish oil capsule provided by the invention includes contents and glue, and the contents comprise the following parts by weight of raw materials:

| | |
|---|---|
| Deep-sea Fish Oil | 160 parts by weights to 200 parts by weights; |
| Fish Squalene | 70 parts by weights to 90 parts by weights; |
| Soybean lecithin | 10 parts by weights to 15 parts by weights; |
| Ginkgo extracts | 7 parts by weights to 12 parts by weights; |
| Vitamin E | 1 part by weights to 3 parts by weights; |
| Beeswax | 15 parts by weights to 30 parts by weights; |

The glue comprises the following parts by weights of raw materials:

| | |
|---|---|
| Gelatin | 80 parts by weights to 120 parts by weights; |
| Water | 80 parts by weights to 120 parts by weights; |
| Glycerin | 30 parts by weights to 50 parts by weights; |
| Brown Iron Oxide | 1 part by weights to 3 parts by weights. |

Wherein the fish oil is any one in tuna oil, cod fish oil or shark oil or the mixture of two or more of them mixed at an arbitrary ratio and the ratio of EPA/DHA contained in the deep-sea fish oil is (2 to 3):1;

The mainly active ingredient of the Ginkgo extracts is flavonoids; wherein the content of flavonoids is 24% (percentage by weight) or more.

Further, the preferred formulation of the deep-sea fish oil capsule described by the invention is as follows:

Calculated on the basis of 1000 tablets of finished products, each tablet is 300 mg:

| | | |
|---|---|---|
| Deep-sea fish oil | 180 | g; |
| Fish squalene | 75.9 | g; |
| Soybean lecithin | 12 | g; |
| Ginkgo extracts | 9 | g; |
| Vitamin E | 2.1 | g; |
| Beeswax | 21 | g; |

The glue includes the following raw materials by weight:

| | | |
|---|---|---|
| Gelatin | 100 | g; |
| Water | 100 | g; |
| Glycerin | 38.6 | g; |
| Brown Iron Oxide | 2 | g |

The preparation method of the deep-sea fish oil provided by the invention comprises the following steps of:

(a) the preparation of the contents: weigh deep-sea fish oil, squalene, soy lecithin, ginkgo extract, vitamin E, and beeswax according to the above formula amount. In view of the process and order, put the above contents in the pot of ingredients one by one to fuse and stir well, and then pour the liquid through the colloid mill, vacuum it, put it in the barrels and cover the barrels, make it cool and stable for later use;

(b) the preparation of the glue: weigh raw materials according to the above formula amount; put them into the preheated pot; heat them, mix them and vacuum them; put the liquid in the barrels after acceptance, and make it steady for later use;

(c) pressing the tablet, making its cover, filling, shaping, drying are done on the production line: the glue flows automatically into the tablet box, the tablet skin wheel rotates to form the tablet skin; the tablet skin on both sides comes into the roller die to form the tablet cover; at the same time, the feed liquid flows through the feed pump into the tablet cover to form the soft capsule, and the capsule goes through the conveyor belt into the roll cage to be shaped and dried;

(d) wash the tablet: after a certain period of time of natural drying after the tablet is set in the plate coming out from the roll cage, the next steps are to wash the tablet, rub the tablet, clear the paraffin oil on its surface, and disinfect;

(e) after washing, the capsules will be dried in the drying room which is purified and with constant temperature and constant humidity;

(f) select the tablets: pick out the substandard capsules, vacuum-pack the qualified capsules with aluminum foil and PVC after wiping and disinfecting them, and then store them; and

(g) pack the finished products: press selected capsules to the plastic inner cores and put the certificate, specification into the outer boxes; paste the sealing checks, put them into the outside chests and then store them.

The beneficial effects of the invention compared with the prior arts are as follows:

The deep-sea fish oil capsules with diversified nutrients provided by the invention have the following benefits:

(1) Prevent and treat cardiovascular and cerebrovascular diseases. Deep-sea fish oil is rich in DHA, EPA, can activate brain cells, lower cholesterol and triglycerides, increase high-density lipoprotein, prevent thrombosis and prevent cardiovascular diseases;

(2) Enhance memory and prevent Alzheimer's. Complementing soybean phospholipids in long term can slow down memory loss, prevent or delay Alzheimer's;

(3) Soften blood vessels, and promote blood circulation. The main active ingredient of Ginkgo is flavonoid. It can protect capillary permeability, expand coronary artery, restore the elasticity of blood vessels and promote blood circulation;

(4) Improve hypoxia tolerance. Squalene itself can release oxygen, so it can strengthen the blood's oxygen-carrying function, accelerate oxygen delivery, improve heart and brain hypoxia, reduce dizziness, chest tightness, shortness of breath, palpitation, insomnia, poor memory and other symptoms; and

(5) Resist oxidation. Vitamin E can scavenge free radicals, defer aging, purify the blood and protect blood vessels.

The preparation method of the deep-sea fish oil provided by the invention is very simple, easy to mass production.

These and other objectives, features, and advantages of the present invention will become apparent from the following detailed description, the accompanying drawings, and the appended claims.

### DETAILED DESCRIPTION OF THE PREFERRED EMBODIMENT

The following further illustrates the technical scheme of the invention in connection with the examples, but sets no limits:

### Example 1

Take the preparation of 1000 tablets of finished products as an example (each tablet of the finished products is 300 mg/tablet) to prepare the deep-sea fish oil capsule:

Comprising the following steps of:

(a) the preparation of the contents: weigh Fish Oil 180 g, squalene 75.9 g, soybean lecithin 12 g, Ginkgo extract 9 g, vitamin E 2.1 g, beeswax 21; in view of the process and order, put the above contents in the pot of ingredients one by one to fuse and stir well, and then pour the liquid through the colloid mill, vacuum it, put it in the barrels and cover the barrels; make it cool and stable for later use;

(b) the preparation of the glue: weigh gelatin 100 g, water 100 g, glycerol 38.6 g, brown iron oxide 2 g; put them into the preheated pot, heat them, mix them and vacuum them; put the liquid in the barrels after acceptance, and make it steady for later use;

(c) pressing the tablet, making its cover, filling, shaping, drying are done on the production line: the glue flows automatically into the tablet box, the tablet skin wheel rotates to form the tablet skin, the tablet skin on both sides comes into the roller die to form the tablet cover, and at the same time, the feed liquid flows through the feed pump into the tablet cover to form the soft capsule; the capsule goes through the conveyor belt into the roll cage to be shaped and dried;

(d) wash the tablet: after a certain period of time of natural drying after the tablet is set in the plate coming out from the roll cage, the next steps are to wash the tablet, rub the tablet, clear the paraffin oil on its surface, and disinfect;

(e) after washing, the capsules will be dried in the drying room which is purified and with constant temperature and constant humidity;

(f) select the tablets: pick out the substandard capsules, vacuum-pack the qualified capsules with aluminum foil and PVC after wiping and disinfecting them, then store them; and

(g) pack the finished products: press the plastic inner cores into the selected capsules, put them and the certificate, specification into the outer boxes, paste the sealing checks, put them into the outside chests and then store them.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A deep-sea fish oil capsule comprising contents and glue, wherein the contents comprise the following weight part of raw materials:

| | |
|---|---|
| Deep-sea Fish Oil | 160 parts by weight to 200 parts by weight; |
| Fish Squalene | 70 parts by weight to 90 parts by weight; |
| Soybean lecithin | 10 parts by weight to 15 parts by weight; |
| Ginkgo extracts | 7 parts by weight to 12 parts by weight; |
| Vitamin E | 1 parts by weight to 3 parts by weight; |
| Beeswax | 15 parts by weight to 30 parts by weight; and |

the glue comprises the following parts by weight of raw materials:

| | |
|---|---|
| Gelatin | 80 parts by weight to 120 parts by weight; |
| Water | 80 parts by weight to 120 parts by weight; |
| Glycerin | 30 parts by weight to 50 parts by weight; and |
| Brown Iron Oxide | 1 part by weight to 3 parts by weight. |

2. The deep-sea fish oil capsule, as recited in claim 1, wherein the fish oil is one of tuna oil, cod fish oil and shark oil or a mixture of two or more of them mixed at an arbitrary ratio.

3. The deep-sea fish oil capsule, as recited in claim 1, wherein a ratio of EPA/DHA contained in the deep-sea fish oil is 2 to 3:1.

4. The deep-sea fish oil capsule, as recited in claim 1, wherein a mainly active ingredient of the Ginkgo extracts is flavonoids, wherein the content of flavonoids is 24% (percentage by weight) or more.

5. The deep-sea fish oil capsule, as recited in claim 1, calculated on the basis of 1000 tablets of finished products and each tablet is 300 mg, the contents comprise the following weight of raw materials:

| | | |
|---|---|---|
| Deep-sea fish oil | 180 | g; |
| Fish squalene | 75.9 | g; |
| Soybean lecithin | 12 | g; |
| Ginkgo extracts | 9 | g; |
| Vitamin E | 2.1 | g; and |
| Beeswax | 21 | g; and |

the glue comprises the following weight of raw materials:

| | | |
|---|---|---|
| Gelatin | 100 | g; |
| Water | 100 | g; |
| Glycerin | 38.6 | g; and |
| Brown Iron Oxide | 2 | g. |

6. A preparation method of the deep-sea fish oil as recited in claim 1, comprising following steps of:
(a) the preparation of the contents: weigh deep-sea fish oil, squalene, soy lecithin, ginkgo biloba extract, vitamin E, beeswax according to the above formula amount; in view of the process and order, put the above contents in the pot of ingredients one by one to fuse and stir well, and then pour the liquid through the colloid mill, vacuum it, put it in the barrels and cover the barrels, and make it cool and stable for later use;
(b) the preparation of the glue: weigh raw materials according to the above formula amount, put them into the preheated pot, heat them, mix them and vacuum them; put the liquid in the barrels after acceptance, and make it steady for later use;
(c) pressing the tablet, making its cover, filling, shaping, drying are done on the production line: the glue flows automatically into the tablet box, the tablet skin wheel rotates to form the tablet skin, the tablet skin on both sides comes into the roller die to form the tablet cover, the same time, the feed liquid flows through the feed pump into the tablet cover to form the soft capsule, the capsule goes through the conveyor belt into the roll cage to be shaped and dried;
(d) wash the tablet: after a certain period of time of natural drying after the tablet is set in the plate coming out from the roll cage, the next steps are to wash the tablet, rub the tablet, clear the paraffin oil on its surface, and disinfect;
(e) after washing, the capsules will be dried in the drying room which is purified and with constant temperature and constant humidity;
(f) select the tablets: pick out the substandard capsules, vacuum-pack the qualified capsules with aluminum foil and PVC after wiping and disinfecting them, and then store them; and
(g) pack the finished products: press the selected capsules into the plastic inner cores, and put the certificate, specification into the outer boxes, paste the sealing checks, put them into the outside chests and then store them.
